(19) United States
(12) Patent Application Publication
(10) Pub. No.: US 2013/0262920 A1
(43) Pub. Date: Oct. 3, 2013

(54) RAID MEMORY SYSTEM

(71) Applicant: SAMSUNG ELECTRONICS CO., LTD., Suwon-si (KR)

(72) Inventors: Min-Wook Jung, Busan (KR); Yang-Sup Lee, Hwaseong-si (KR)

(73) Assignee: SAMSUNG ELECTRONICS CO., LTD., Suwon-si (KR)

(21) Appl. No.: 13/771,477

(22) Filed: Feb. 20, 2013

(30) Foreign Application Priority Data
Apr. 2, 2012 (KR) 10-2012-0034010

(51) Int. Cl. G06F 11/10; G06F 3/06

(52) U.S. Cl. CPC G06F 11/1076; G06F 3/0689
USPC 714/6.22; 711/114

(57) ABSTRACT

A redundant array of inexpensive or independent disks (RAID) memory system comprises a nonvolatile memory device and a memory controller. The nonvolatile memory comprises a stripe block. The memory controller determines a value based on at least one of a program/erase (P/E) cycle and a read error frequency of the stripe block and determines whether to change a size of the stripe block based on the determined value.

### CROSS-REFERENCE TO RELATED APPLICATION

This application claims priority to Korean Patent Application No. 10-2012-0034010, filed on Apr. 2, 2012 in the Korean Intellectual Property Office, the disclosure of which is incorporated by reference in its entirety herein.

### BACKGROUND

1. Technical Field

Embodiments of the inventive concept relate to a redundant array of independent or inexpensive disks (RAID) memory system.

2. Discussion of Related Art

A redundant array of independent or inexpensive disks (RAID) is a technology used to store important data. When a data error occurs in a storage device of the RAID, a RAID recovery is performed using RAID parity to recover the data. Therefore, RAID can improve the overall performance of a server.

Currently, sold state drives (SSDs) are ever increasingly replacing hard disk drives (HDDs). A semiconductor memory used in an SSD may include, for example, NAND flash memory chips. A stripe may be defined as a basic unit of RAID parity, and a plurality of pages may form a stripe page that is a basic unit of a parity page. In addition, a RAID recovery may be performed on a stripe page-by-stripe page basis.

In a storage device including a plurality of NAND flash memory chips, the number of pages that constitute a stripe page is static. For example, in the storage device, the number of pages that constitute a stripe page is constant and maintained at an initially set value.

However, when the number of pages that constitute a stripe page in a RAID is high, an error recovery rate through RAID recovery may be low. Thus, there is need for reducing the number of pages that constitute a stripe page.

### SUMMARY

At least one embodiment of the inventive concept provides a redundant array of independent or inexpensive disks (RAID) memory system which can optimize an error recovery rate through RAID recovery by dynamically changing a size of a stripe.

According to an exemplary embodiment of the inventive concept, a redundant array of inexpensive disks (RAID) memory system includes a nonvolatile memory device having a stripe block and a memory controller. The memory controller is configured to determine a value based on at least one of a program/erase (PIE) cycle and a read error frequency of the stripe block and determines whether to change a size of the stripe block based on the determined value.

According to an exemplary embodiment of the present inventive concept, a RAID memory system includes a nonvolatile memory device having a plurality of nonvolatile memory chips and a plurality of stripe blocks, and a memory controller. Each memory chip has a plurality of physical blocks. The memory controller performs a RAID recovery when an error occurs in one of the physical blocks included in the nonvolatile memory device. The nonvolatile memory device records first data about what physical blocks are included in each stripe block, second data about in which of the stripe blocks each physical block is included and third data about at least one of a P/E cycle and a read error frequency of each physical block, and performs the RAID recovery by searching for one of the stripe blocks which comprises the one physical block using the second data, searching for a plurality of the physical blocks included in the one stripe block using the first data, and recovering error data using data stored in pages of the found physical blocks.

According to an exemplary embodiment of the inventive concept, a redundant array of inexpensive disks (RAID) memory system includes a nonvolatile memory device having a stripe block and a memory controller. The memory controller is configured to determine a reliability of data stored in the stripe block. The memory controller decreases a size of the stripe block when the reliability is below a threshold value, increases a size of the stripe block when the reliability is above the threshold value, and keeps the size of the stripe block constant when the reliability is equal to the threshold value.

### BRIEF DESCRIPTION OF THE DRAWINGS

The present inventive concept will become more apparent by describing in detail exemplary embodiments thereof with reference to the attached drawings, in which:

FIG. 1 is a block diagram of a redundant array of independent or inexpensive disks (RAID) memory system according to an exemplary embodiment of the present inventive concept;

FIGS. 2 and 3 are block diagrams of a nonvolatile memory device shown in FIG. 1;

FIG. 4 is a block diagram of a nonvolatile memory chip shown in FIG. 3;

FIGS. 5 and 6 are block diagrams illustrating a method of changing a stripe block size of a RAID memory system according to an exemplary embodiment of the present inventive concept;

FIG. 7 is a flowchart illustrating a RAID recovery method of a RAID memory system according to an exemplary embodiment of the present inventive concept; and

FIG. 8 is a block diagram illustrating the RAID recovery method of FIG. 7.

### DETAILED DESCRIPTION

The present inventive concept may be understood more readily by reference to the following detailed description of exemplary embodiments thereof and the accompanying drawings. The present inventive concept may, however, be embodied in many different forms and should not be construed as being limited to the exemplary embodiments set forth herein. In the drawings, the thickness of layers and regions may be exaggerated for clarity. The use of the terms “a” and “an” and “the” are intended to include the plural forms as well, unless the context clearly indicates otherwise.

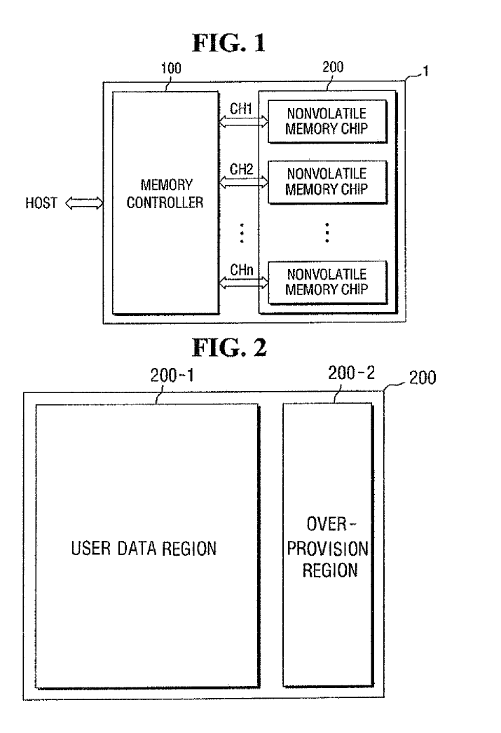

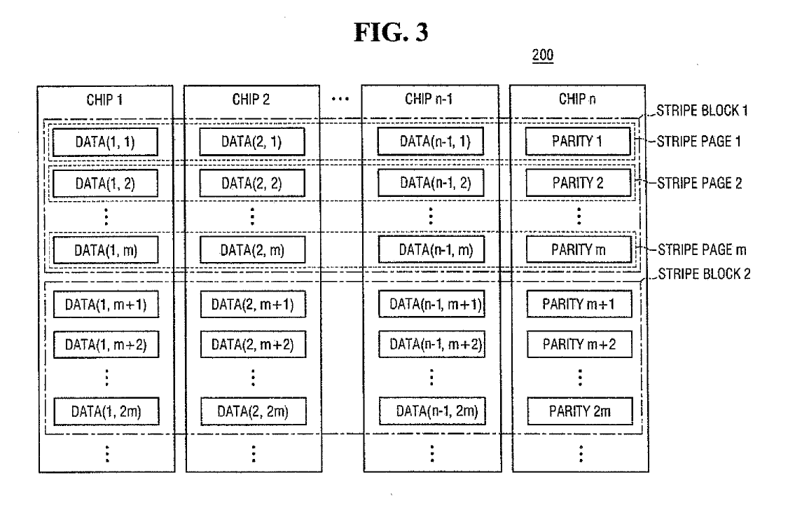

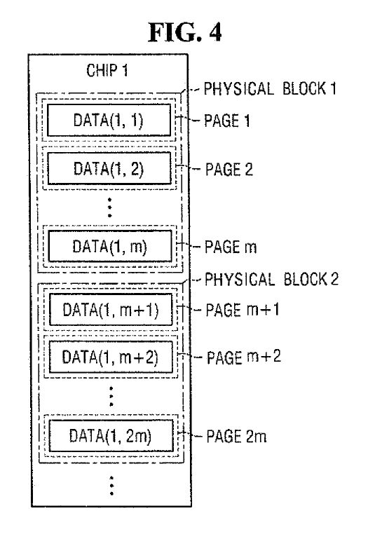

The configuration of a redundant array of inexpensive or independent disks (RAID) memory system according to an exemplary embodiment of the present inventive concept will be described with reference to FIGS. 1 through 4. FIG. 1 is a block diagram of a RAID memory system 1 according to an exemplary embodiment of the present inventive concept. FIGS. 2 and 3 are block diagrams of a nonvolatile memory device 200 shown in FIG. 1. FIG. 4 is a block diagram of a nonvolatile memory chip shown in FIG. 3. Referring to FIG. 1, the RAID memory system 1 includes a memory controller 100 and the nonvolatile memory device 200.

The RAID memory system 1 has a RAID architecture and may use at least one error correction code (ECC) to prevent data loss due to errors to increase data reliability. However, embodiments of the present inventive concept are not limited thereto.

The RAID architecture used in at least embodiment of the inventive concept may have various levels. For example, the RAID architecture may have any one of RAID level 0 (striped set without parity or striping), RAID level 1 (mirrored set without parity or mirroring), RAID level 2 (hamming code parity), RAID level 3 (striped set with dedicated parity, bit interleaved parity, or byte level parity), RAID level 4 (block level parity), RAID level 5 (striped set with distributed parity or interleave parity), RAID level 6 (striped set with dual distributed parity), RAID level 7, RAID level 10 and RAID level 53, or a RAID level (e.g., RAID 0+1, RAID 1+0, RAID 5+0, RAID 5+1, or RAID 0+1+5) obtained by merging at least two of the above RAID levels.

The memory controller 100 may be coupled to a host and the nonvolatile memory device 200. The memory controller 100 may be configured to access the nonvolatile memory device 200 in response to a request from the host. For example, the memory controller 100 may be configured to control read/program/erase operations of the nonvolatile memory device 200. For example, the memory controller 100 may be read data from the device 200, write data to the device 200, or erase data from the device 200.

In at least one embodiment of the inventive concept, the memory controller 100 generates a RAID parity based on data output from the host. For example, the memory controller 100 may generate a RAID parity by performing an XOR operation on multiple data. In addition, the memory controller 100 may perform a RAID recovery on the nonvolatile memory device 200. A method of performing a RAID recovery will be described later.

In at least one embodiment of the inventive concept, the memory controller 100 is configured to provide an interface between the nonvolatile memory device 200 and the host. The memory controller 100 may be configured to drive firmware for controlling the nonvolatile memory device 200.

The nonvolatile memory device 200 may include a plurality of nonvolatile memory chips. The nonvolatile memory chips may communicate with the memory controller 100 through, e.g., first through n^{th} channels CH1 through CHn (where n is a natural number).

Memory cells used in each or at least one nonvolatile memory chip may be a flash memory, an electrically erasable programmable read-only memory (EEPROM), a magnetic random access memory (MRAM), a spin-transfer torque MRAM, a conductive bridging RAM (CBRAM), a ferroelectric RAM (FeRAM), a phase change RAM(PRAM) also called an ovonic unified memory (OUM), a resistive RAM (RRAM or ReRAM), a nanotube RRAM, a polymer RAM (PoRAM), a nano floating gate memory (NFGM), a holographic memory, a molecular electronics memory device or an insulator resistance change memory.

The RAID memory system 1 may be integrated as one semiconductor device to form a memory card such as a personal computer (PC) card (e.g., personal computer memory card international association (PCMCIA)), a compact flash card (CF), a smart media card (SM/SMC), a memory stick, a multimedia card (e.g., MMC, RS-MMC, MMCmicro), a SD card (e.g., SD, miniSD, microSD, SDHC), or a universal flash storage (UFS).

The RAID memory system 1 may be integrated as one semiconductor device to form a solid state drive (SSD). When the memory controller 100 and the nonvolatile memory device 200 are integrated as one semiconductor device and used as an SSD, the operation speed of the host connected to the RAID memory system 1 may be improved.

As another example, the memory system 1000 may be one of various components of electronic devices such as a computer, an ultra-mobile PC (UMPC), a workstation, a net-book, a personal digital assistant (PDA), a portable computer, a tablet, a wireless phone, a mobile phone, a smart phone, an e-book, a portable multimedia player (PMP), a portable game device, a navigation device (e.g., GPS), a black box, a digital camera, a television (e.g., three-dimensional), a digital audio recorder, a digital audio player, a digital picture recorder, a digital picture player, a digital video recorder, a digital video player, a device capable of transmitting/receiving information in a wireless environment, one of various electronic devices constituting a home network, one of various electronic devices constituting a computer network, one of various electronic devices constituting a telematics network, a radio frequency identification (RFID) device, or one of various components constituting a computing system.

The RAID memory system 1 may be mounted in various types of packages. For example, the RAID memory system 1 may be packaged using various methods such as Package on Package (PoP), Ball Grid Array (BGA), Chip Scale Package (CSP), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), Thin Quad Flat Pack (TQFP), System In Package (SIP), Multi Chip Package (MCP), Wafer-level Fabricated Package (WFP), and Wafer-level Processed Stack Package (WSP).

Referring to FIG. 2, the nonvolatile memory device 200 includes a user data region 200-1 where user data is stored and an over-provision region 200-2 where data other than the user data is stored. In at least one embodiment of the inventive concept, the user data region 200-1 and the over-provision region 200-2 are not physically separated from each other. The nonvolatile memory device 200 can recognize in which of the user data region 200-1 and the over-provision region 200-2 data is stored based on the type of the stored data.

For example, RAID parities may be stored in the over-provision region 200-2. In at least one embodiment of the inventive concept, the over-provision region 200-2 stores first data about what physical blocks are included in each stripe block, second data about in which of a plurality of stripe blocks each physical block is included, and third data about at least one of a program/erase (P/E) cycle and a read error frequency of each physical block. For example, the first data could indicate that the first stripe block STRIPE BLOCK 1 includes 1^{St}-4^{th} physical blocks, the second data could indicate that the 2^{nd} block is included in the first stripe block STRIPE BLOCK 1, and the third data could indicate that the 2^{nd} block was already programmed or erased 10,000 times or has a read error frequency of once out of every 5,000 reads, etc. For example, a flash memory may have a finite number of P/E cycles that it is guaranteed to withstand before the wear begins to deteriorate the integrity of the storage. The first through third data will be described in more detail later. Data stored in the over-provision region 200-2 is not limited to the above data.

Referring to FIGS. 1, 3 and 4, the nonvolatile memory device 200 includes n nonvolatile memory chips CHIP 1 through CHIPn (where n is a natural number). The n nonvolatile memory chips CHIP1 through CHIPn may correspond to channels CHIT through CHn, respectively. Here, the channels CH1 through CHn may be one or more data lines through which data and RAID parities are transmitted.

Each of the nonvolatile memory chips CHIP 1 through CHIPn may include a plurality of physical blocks. Each block may include a plurality of pages. A physical block is a basic unit of an erase operation, and a page is a basic unit of a read and program (or write) operation. In at least one embodiment, erasure requires that an entire block be erased, while reading or writing can be performed on a lesser portion of an entire block (e.g., one page of the block).

Each of the nonvolatile memory chips CHIP 1 through CHIPn may include a plurality of pages. Each page may store page data (DATA (x, y), where x and y are natural numbers) or a RAID parity.

For example, one physical block may include in pages, where m is a natural number. A first physical block PHYSICAL BLOCK1 of the first nonvolatile memory chip CHIP1 may include first through m^{th} pages PAGE1 through PAGEm, and a second physical block PHYSICAL BLOCK2 of the first nonvolatile memory chip CHIP1 may include (m+1)^{th} through (2m)^{th} pages PAGEm+1 through PAGE2m.

For example, when memory cells used in each of the nonvolatile memory chips CHIP 1 through CHIPn are single level cells, each physical block may include 64 pages. When the used memory cells are multilevel cells, each physical block may include 128 pages. When the used memory cells are triple level cells, each physical block may include 192 pages. However, the use of 64 pages for single level cells is merely an example, as single level cells may correspond to various other numbers of pages (e.g., 32). Likewise, the number of pages corresponding to multilevel cells and triple level cells can also vary.

The nonvolatile memory device 200 may include a plurality of stripe pages and a plurality of stripe blocks. A RAID parity is used for RAID recovery, and a stripe may be defined as a basic unit of the RAID parity. A stripe page is a basic unit of a RAID parity page PARITY PAGE and may include a plurality of pages used to generate a RAID parity page PARITY PAGE. For example, a first stripe page STRIPE PAGE1 may include a plurality of pages used to generate a first RAID parity page PARITY1. The pages used to generate the first RAID parity page PARITY1 may be respective first pages of the first through (n−1)^{th} nonvolatile memory chips CHIP1 through CHIPn−1. In addition, the first RAID parity page PARITY1 may be generated by performing an XOR operation on data DATA (1, 1) through DATA (n−1, 1) stored in the first pages of the first through (n−1)^{th} nonvolatile memory chips CHIP1 through CHIPn−1.

In FIG. 3, RAID level 4 is applied. Thus, all RAID parity pages are stored in the n^{th} nonvolatile memory chip CHIPn. However, the present inventive concept is not limited thereto, as the RAID parity pages can also be stored in a nonvolatile memory chip other than the n^{th} nonvolatile memory chip CHIPn.

A plurality of stripe pages may form a stripe block. For example, a first stripe block STRIPE BLOCK1 may include first through m^{th} stripe pages STRIPE PAGE1 through STRIPE PAGEm. The size of a stripe block may be determined to be a multiple of the size of a physical block. For example, since an equal number of stripe pages to the number of pages that constitute one physical block form one stripe block, the size of a stripe block may be a multiple of the size of a physical block.

In summary, the nonvolatile memory device 200 may include a plurality of nonvolatile memory chips CHIP 1 through CHIPn, each having physical blocks. In addition, the nonvolatile memory device 200 may include a plurality of stripe blocks, each having a plurality of physical blocks.

The size of a stripe block or a stripe page may affect the reliability and performance of the RAID memory system 1.

One stripe page includes n pages. Accordingly, one stripe block includes n physical blocks. As the number of pages that constitute a stripe page decreases, an error recovery rate using RAID recovery may increase. However, as the number of pages that constitute a stripe page decreases, the number of stripe pages existing in the nonvolatile memory device 200 may increase. Therefore, the number of RAID parity pages may also increase. As described above, RAID parity pages may be stored in the over-provision region 200-2. Thus, an increase in the number of RAID parity pages may lead to a reduction in an available space of the over-provision region 200-2, resulting in a reduction in a write amplification factor WAF.

Conversely, as the number of pages that constitute a stripe page increases, an error recovery rate using RAID recovery may decrease. In addition, an increase in the number of pages that constitute a stripe page may lead to an increase in the number of pages that need to be read during a RAID recovery performed when a read error that cannot be recovered using ECC occurs. However, as the number of pages that constitute a stripe page increases, the number of stripe pages existing in the nonvolatile memory device 200 may decrease. Therefore, the number of RAID parity pages may decrease. A decrease in the number of RAID parity pages may lead to an increase in the available space of the over-provision region 200-2, resulting in an increase in WAF.

As described above, the size of a stripe block or the size of a stripe page affects the reliability and performance of the RAID memory system 1. Therefore, the size of a stripe block may be adjusted to maintain the reliability of the RAID memory system 1 according to an exemplary embodiment of the inventive concept to optimize the performance of the RAID memory system 1.

In the RAID memory system 1 according to an exemplary embodiment of the inventive concept, the size of a stripe block in the nonvolatile memory device 200 may be changed. Changing the size of a stripe block may denote changing the number of physical blocks included in the stripe block.

In an exemplary embodiment of the inventive concept, the memory controller 100 determines the reliability of data stored in a stripe block and decides whether to change the size of the stripe block based on the determined result. In at least one embodiment of the inventive concept, the reliability of data is determined based on at least one of the P/E cycle and the read error frequency. For example, the memory controller 100 measures at least one of the P/E cycle and read error frequency of each stripe block and determines whether to change the size of each stripe block based on the measured values. However, criteria used to determine the reliability of data stored in a stripe block are not limited to the P/E cycle and the read error frequency.

Since the P/E cycle can be a criterion for determining how old a stripe block is, it can be used to determine the reliability of data stored in the stripe block. In addition, since the read error frequency can be a criterion for directly indicating the reliability of data stored in a stripe block, it can be used to determine the reliability of data stored in the stripe block.

Various methods may be used for measuring at least one of the P/E cycle and read error frequency of a stripe block and determining whether to change the size of the stripe block based on the measured values.

For example, an operation may be performed using the measured values, and whether to change the size of a stripe block may be determined based on the result of the operation. If a variable related to the P/E cycle is m1 and if a variable related to the read error frequency is m2, an expression can be set up as N(a*m1+b*m2), where a and b are constants. Therefore, the result of the operation can be obtained by substituting a value of the measured P/E cycle and a value of the measured read error frequency into the expression, and whether to change the size of a stripe block can be determined based on the operation result. When it is determined that the size of the stripe block is to be changed, the degree to which the size of the stripe block is to be changed may also be determined.

TABLE 1

| N(a*m1 + b*m2) Value | Stripe Block Size |
|---|---|
| M0 < N(a*m1 + b*m2) < M1 | N1 |
| M1 < N(a*m1 + b*m2) < M2 | N2 |
| . . . | . . . |
| Mk − 1 < N(a*m1 + b*m2) < Mk | Nk |
| | N1 > N2 > Nk |

Referring to Table 1, a stripe block size is set for each value of N(a*m1+b*m2). Therefore, whether to change the size of a stripe block and the degree to which the stripe block is to be changed can be determined based on an operation result. If a stripe block size corresponding to an operation result is equal to a size of a current stripe block, there is no need to change the size of the current stripe block. For example, if ‘a’=1, ‘b’=0, and a given stripe block was programmed and/or erased a total of 1,000 times, the operation result would be 1000 (e.g., 1*1000+0*m2=1000). Further, assume the size of the given stripe block is currently 128 blocks, an operation result between 500 and 2000 indicates a stripe block size should be 128 physical blocks and an operation result between 2001 and 4000 indicates a stripe block size should be 64 physical blocks. Thus, in this example, the stripe block size of the given stripe block would be kept at 128 physical blocks since the operation result is between 500 and 2000, and the size of the given stripe block is also 128 blocks.

However, if the stripe block size corresponding to the operation result is not equal to the size of the current stripe block, the size of the current stripe block will be changed. If the stripe block size corresponding to the operation result is smaller than the size of the current stripe block, the size of the current stripe block is divided into a plurality of smaller sized stripe blocks. For example, since the data reliability of the current stripe block is low, the error recovery rate using RAID recovery may be increased by reducing the size of the current stripe block. In so doing, the reliability of the RAID memory system 1 may be increased. For example, assuming ‘a’ and ‘b’ are constant (e.g., ‘a’=1 and ‘b’=0), and now the given stripe block was programmed and/or erased 3000 times, the operation result based on the above described ranges (e.g., 500-2000 and 2001-4000) would indicate that the stripe block size should be 64 blocks. However, since the given stripe block has a current size of 128 blocks, the memory controller 100 decreases the size of the given stripe block to 64 blocks.

When the stripe block size corresponding to the operation result is greater than the size of the current stripe block, the size of the current stripe block is increased by, for example, merging the current stripe block with another stripe block. For example, since the data reliability of the current stripe block is high, the size of the current stripe block may be increased, thereby increasing WAF. Accordingly, the performance of the RAID memory system 1 can be increased. For example, if ‘a’ is changed to 0, ‘b’ is changed to 1, and the read error frequency of the given stripe block is 1200, it results in an operation result of 1200. Based on the above described ranges (e.g., 500-2000 and 2001-4000), an operation result of 1200 would indicate that the given stripe block should have a size of 128 blocks. However, since the given stripe block is currently 64 blocks, the memory controller 100 increases the size of the given stripe block to 128 blocks.

In summary, when an operation result value is high since a measured P/E value and a measured read error frequency value are high, a corresponding stripe block may be old, and an error rate may be high. Accordingly, data reliability may be low. For example, the error recovery rate using RAID recovery needs to be increased. Therefore, as the operation result value increases, the size of a corresponding stripe block may decrease. Consequently, as a basic unit of a stripe block is reduced, the error recovery rate using RAID recovery may increase, thereby increasing the overall data reliability of the RAID memory system 1.

Additionally, whether to change the stripe block size can be determined individually for each stripe block, which may help to optimize the performance of the RAID memory system 1. Consequently, stripe blocks of different sizes may exist in the nonvolatile memory device 200.

The above expression is merely an example used to describe an exemplary embodiment of the present inventive concept. A different expression can be used as long as it uses at least one of the P/E cycle and the read error frequency as a variable and produces an operation result that reduces the stripe block size as data reliability is reduced.

Based on an operation result, the memory controller 200 changes the size of the stripe block. When the size of the stripe block is changed, a basic unit of a RAID parity is changed. Therefore, the memory controller 200 can generate a new RAID parity. Consequently, the RAID parity before the size of the stripe block is changed may be different from the new RAID parity after the size of the stripe block is changed. The RAID parity may be defined as RAID parity pages included in the same stripe block.

As the size of the stripe block is changed, the number of RAID parities existing in the nonvolatile memory device 200 may change. Therefore, the number of RAID parities stored in the nonvolatile memory device 200 before the size of the stripe block is changed may be different from the number of RAID parities stored in the nonvolatile memory device 200 after the size of the stripe block is changed.

The memory controller 100 may measure at least one of the P/E cycle and read error frequency of a stripe block according to an exemplary embodiment of the inventive concept as follows.

As described above, the over-provision region 200-2 of the nonvolatile memory device 200 may store the first data about what physical blocks are included in each stripe block, the second data about in which of a plurality of stripe blocks each physical block is included, and the third data about at least one of the P/E cycle and the read error frequency of each physical block. The above data can be updated frequently whenever data is changed.

For example, to measure the P/E cycle of a specific stripe block, the memory controller 100 may search for a plurality of physical blocks included in the specific stripe block using the first data and collect P/E cycles by finding the third data of the physical blocks. In at least one embodiment of the inventive concept, the P/E cycle for the specific stripe block is the sum of the number of collected P/E cycles, an average of the number of collected P/E cycles, or the highest one of the collected P/E cycles.

Likewise, to measure the read error frequency of a specific stripe block, the memory controller 100 may search for a plurality of physical blocks included in the specific stripe block and collect read error frequencies by finding the third data of the physical blocks. In at least one embodiment of the inventive concept, the read error frequency for the specific stripe block is an average of the collected read error frequencies or the highest one of the read error frequencies.

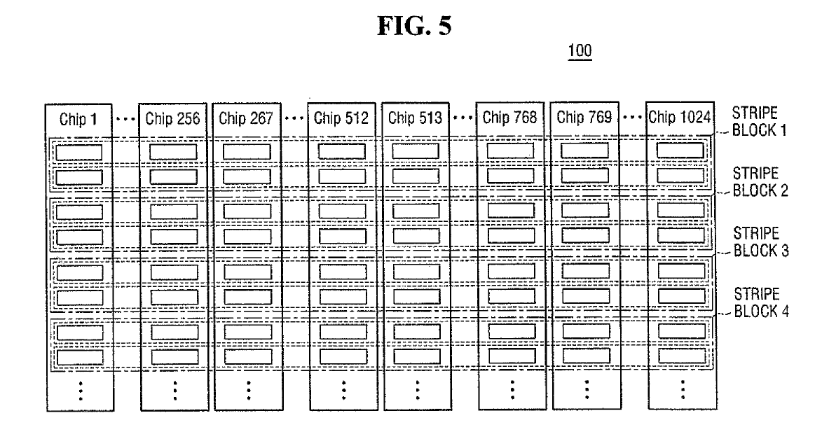

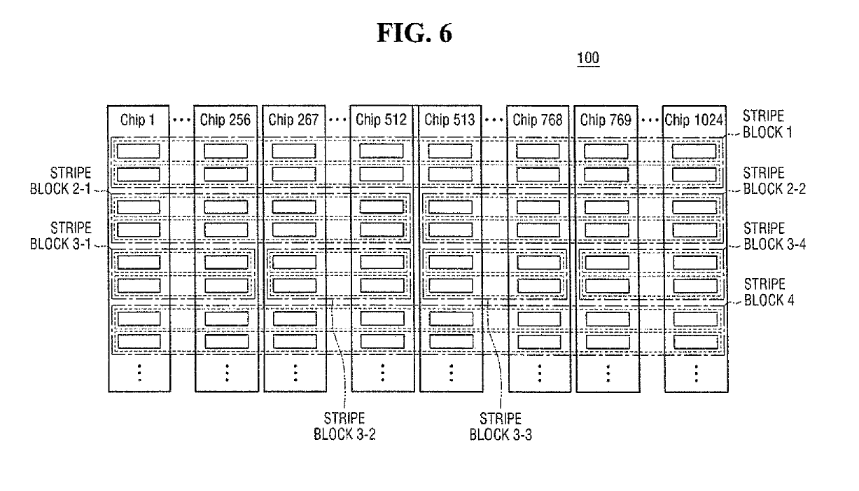

A method of changing a stripe block of the nonvolatile memory device 200 according to an exemplary embodiment of the inventive concept will now be described in detail with reference to FIGS. 5 and 6. FIGS. 5 and 6 are block diagrams illustrating a method of changing a stripe block size of a RAID memory system according to an exemplary embodiment of the present inventive concept.

In FIGS. 5 and 6, an example where the number of nonvolatile memory chips CHIP1 through CHIP1024 is 1024 is illustrated. A nonvolatile memory device 200 may include a plurality of stripe blocks. In FIG. 5, all stripe blocks are the same size. However, this is merely an exemplary illustration for ease of description. For example, the nonvolatile memory device 200 may include stripe blocks of various sizes.

A first stripe block STRIPE BLOCK1 and a fourth stripe block STRIPE BLOCK4 are examples of a stripe block size corresponding to an operation result being equal to a size of a current stripe block. In this example, there is no need to change the size of the current stripe block. Therefore, in FIGS. 5 and 6, a size of the first stripe block STRIPE BLOCK1 and a size of the fourth stripe block STRIPE BLOCK4 remain unchanged.

A second stripe block STRIPE BLOCK2 and a third stripe block STRIPE BLOCK3 are examples of a stripe block size corresponding to the operation result being smaller than the size of the current stripe block. In this example, the current stripe block is divided into a plurality of stripe blocks. For example, the data reliability of the third stripe block STRIPE BLOCK3 is evaluated as being lower than that of the second stripe block STRIPE BLOCK2. For example, an operation result value for the third stripe block STRIPE BLOCK3 is higher than an operation result value for the second stripe block STRIPE BLOCK2. Therefore, the third stripe block STRIPE BLOCK3 is divided into relatively smaller stripe blocks than those of the second stripe block STRIPE BLOCK2.

Consequently, the second stripe block STRIPE BLOCK2 composed of 1024 physical blocks may be divided into (2-1)^{th} and (2-2)^{th} stripe blocks STRIPE BLOCK2-1 and STRIPE BLOCK2-2, each composed of 512 physical blocks. In addition, the third stripe block STRIPE BLOCK3 composed of 1024 physical blocks may be divided into (3-1)^{th} through (3-4)^{th} stripe blocks STRIPE BLOCK3-1 through STRIPE BLOCK3-4, each composed of 256 physical blocks. While the second stripe block STRIPE BLOCK2 and third stripe block STRIPE BLOCK3 are described as including 1024 physical blocks, embodiments of the inventive concept are not limited thereto. For example, if the stripe blocks had 512 physical blocks, the second stripe block STRIPE BLOCK2 could have divided into smaller stripe blocks of 256 physical blocks while the third stripe block STRIPE BLOCK3 could have been divided into smaller stripe blocks of 128 physical blocks.

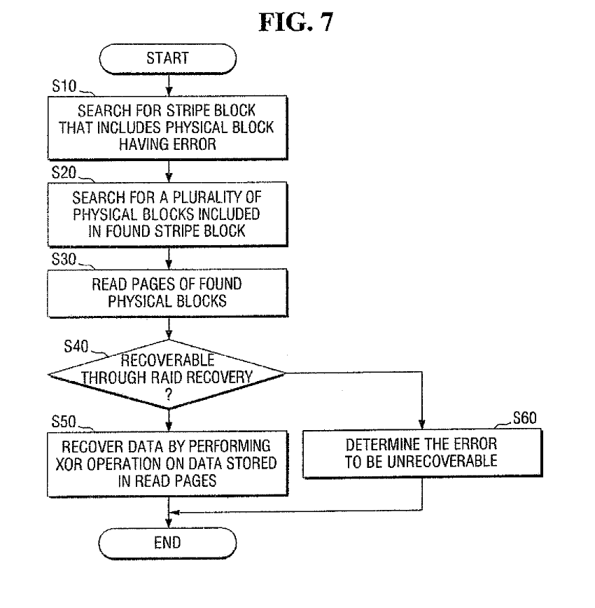

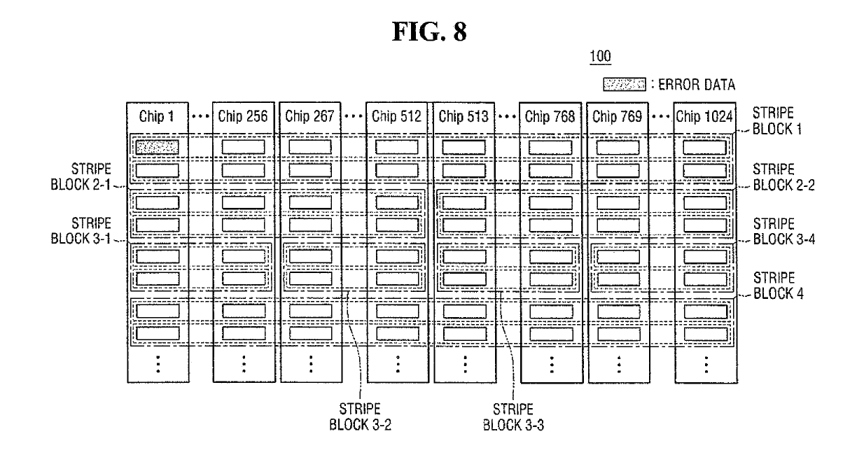

A RAID recovery method of a RAID memory system according to an exemplary embodiment of the present inventive concept will now be described with reference to FIGS. 7 and 8. FIG. 7 is a flowchart illustrating a RAID recovery method of a RAID memory system according to an exemplary embodiment of the present inventive concept. FIG. 8 is a block diagram illustrating the RAID recovery method of FIG. 7.

Referring to FIGS. 7 and 8, when a read error that cannot be recovered using ECC occurs in a page included in a specific physical block, a memory controller 100 performs a RAID recovery.

The memory controller 100 identifies in which stripe block the physical block having the error is included (operation S10). Second data stored in a nonvolatile memory device 200 may be used to identify the stripe block. Since the second data indicates in which of a plurality of stripe blocks each physical block is included, which stripe block includes the physical block having the error can be identified using the second data.

When an error occurs in a first page of a first nonvolatile memory chip CHIP1, it can be identified using the second data. For example, the second data indicates that a physical block including the first page of the first nonvolatile memory chip CHIP1 is included in a first stripe block STRIPE BLOCK1.

Next, other physical blocks included in a stripe block that includes the physical block having the error are searched for (operation S20). First data stored in the nonvolatile memory device 200 may be used to search for the other blocks. Since the first data indicates what physical blocks are included in each stripe block, other physical blocks included in the stripe block that includes the physical block having the error can be searched for using the first data.

For example, other physical blocks included in the first stripe block STRIPE BLOCK1 can be searched for using the first data.

Next, pages of the found physical blocks included in the stripe block that includes the physical block having the error are read (operation S30). Data for the RAID recovery can be obtained by reading the pages of the found physical blocks.

For example, pages of the found physical blocks included in the first stripe block STRIPE BLOCK1 may be read. For example, first pages of second through 1024^{th} nonvolatile memory chips CHIP2 through CHIP1024 may be read.

A determination is made as to whether the error can be recovered through the RAID recovery (operation S40). If it is determined that the error can be recovered through the RAID recovery, data may be recovered by performing an XOR operation on a plurality of read data (operation S50). For example, error data can be recovered using data stored in the pages of the found physical blocks. However, if the error cannot be recovered through the RAID recovery, the error may be determined to be an unrecoverable error (operation S60).

For example, when it is determined that the error can be recovered through the RAID recovery, data of the first page of the first nonvolatile memory chip CHIP1 can be recovered by performing an XOR operation on a plurality of data read from the first pages of the second through 1024^{th} nonvolatile memory chips CHIP2 through CHIP1024.

Although the present inventive concept has been described in connection with exemplary embodiments thereof, those skilled in the art will appreciate that various modifications can be made to these embodiments without substantially departing from the principles of the disclosure.

What is claimed is:

1. A redundant array of inexpensive disks (RAID) memory system comprising:
a nonvolatile memory device comprising a stripe block; and
a memory controller configured to determine a value based on at least one of a program/erase (P/E) cycle and a read error frequency of the stripe block and determine whether to change a size of the stripe block based on the determined value.

2. The RAID memory system of claim 1, wherein the memory controller determines a reliability of data stored in the stripe block using the determined value, and determines whether to change the size of the stripe block based on the determined reliability.

3. The RAID memory system of claim 2, wherein the memory controller determines whether to change the size of the stripe block based on the determined reliability and a degree to which the size of the stripe block is to be changed.

4. The RAID memory system of claim 1, wherein the stripe block comprises a first RAID parity and the memory controller generates a second RAID parity corresponding to the stripe block of the changed size.

5. The RAID memory system of claim 4, wherein a first number of RAID parity parities stored in the nonvolatile memory device before the change of size is different from a second number of RAID parity parities stored in the nonvolatile memory device after the change of size.

6. The RAID memory system of claim 2, wherein the size of the stripe block is reduced when the determined reliability is increased.

7. The RAID memory system of claim 1, wherein the nonvolatile memory device comprises a plurality of nonvolatile memory chips, each having a plurality of physical blocks, wherein each stripe block comprises some of the physical blocks.

8. The RAID memory system of claim 7, wherein the change of the size of the stripe block changes the number of the physical blocks that constitute the stripe block.

9. The RAID memory system of claim 7, wherein the nonvolatile memory device records first data about what physical blocks are included in each stripe block, second data about in which of the stripe blocks each physical block is included, and third data about at least one of the P/E cycle and the read error frequency of each physical block.

10. The RAID memory system of claim 9, wherein the determination of the at least one of the P/E cycle and the read error frequency of the stripe block is performed by collecting the third data of the physical blocks included in the stripe block.

11. The RAID memory system of claim 9, wherein the memory controller performs a RAID recovery when an error occurs in one of the physical blocks included in the nonvolatile memory device, wherein the performing of the RAID recovery comprises searching for one of the stripe blocks which comprises the one physical block using the second data, searching for a plurality of the physical blocks included in the one stripe block using the first data, and recovering error data using data stored in pages of the found physical blocks.

12. A RAID memory system comprising:
a nonvolatile memory device comprising a plurality of nonvolatile memory chips and a plurality of stripe blocks, each memory chip having a plurality of physical blocks, and each stripe block including some of the physical blocks; and
a memory controller configured to perform a RAID recovery when an error occurs in one of the physical blocks included in the nonvolatile memory device,
wherein the nonvolatile memory device records first data about what physical blocks are included in each stripe block, second data about in which of the stripe blocks each physical block is included and third data about at least one of a P/E cycle and a read error frequency of each physical block, and performs the RAID recovery by searching for one of the stripe blocks which comprises the one physical block using the second data, searching for a plurality of the physical blocks included in the one stripe block using the first data, and recovering error data using data stored in pages of the found physical blocks.

13. The RAID memory system of claim 12, wherein the stripe blocks comprise first and second stripe blocks, wherein a size of the first stripe block is different from a size of the second stripe block.

14. The RAID memory system of claim 12, wherein the memory controller determines a value based on at least one of the P/E cycle and the read error frequency of each stripe block and determines whether to change the size of each stripe block based on the determined values.

15. The RAID memory system of claim 14, wherein in the determining of whether to change the size of each stripe block based on the determined values, a reliability of data stored in each stripe block is determined using the determined values, and whether to change the size of each stripe block is determined based on the corresponding reliability.

16. A redundant array of inexpensive disks (RAID) memory system comprising:
a nonvolatile memory device comprising a stripe block; and
a memory controller configured to determine a reliability of data stored in the stripe block, wherein the memory controller decreases a size of the stripe block when the reliability is below a threshold value, increases a size of the stripe block when the reliability is above the threshold value, and keeps the size of the stripe block constant when the reliability is equal to the threshold value.

17. The RAID memory system of claim 16, wherein the reliability is based on at least one of a P/E cycle and a read error frequency of the stripe block.

18. The RAID memory system of claim 16, wherein the reliability is a sum of a first term based on the P/E cycle and a second term based on the read error frequency.

19. The RAID memory system of claim 18, wherein the first term includes a first variable multiplied by the P/E cycle and the second term includes a second variable multiplied by the read error frequency.

20. The RAID memory system of claim 16, wherein increasing the size of the stripe block increases a number of physical blocks located within the stripe bock and decreasing the size of the stripe block decreases the number of physical blocks.
